(19) United States
(12) Patent Application Publication
(10) Pub. No.: US 2018/0061008 A1
(43) Pub. Date: Mar. 1, 2018

(54) IMAGING SYSTEM AND METHOD

(71) Applicant: Autoliv ASP, Inc., Ogden, UT (US)

(72) Inventors: Alexander L. Kormos, Solvang, CA (US); Louis Joseph Mathieu, Goleta, CA (US)

(21) Appl. No.: 15/253,159

(22) Filed: Aug. 31, 2016

(51) Int. Cl. G06T 5/00; H04N 7/18; G06K 9/00; H04N 5/33; G06T 5/50; H04N 5/225

(52) U.S. Cl. CPC G06T 5/001; H04N 7/181; G06K 9/00791; H04N 5/33; B60S 1/02; H04N 5/2254; G06T 2207/30252; G06T 2207/10048; G06T 2207/20224; G06T 5/50

(57) ABSTRACT

An imaging system and method includes an imaging sensor, a processor in communication with the imaging sensor, a protective window or other exposed optical surface located between the imaging sensor and the scene to be captured by the imaging sensor, and a heater system in thermal communication with the window or other exposed optical surface. The imaging sensor configured to capture images of a scene, each of the captured images comprising a plurality of pixels. The processor is configured to receive information representing the images comprising the plurality of pixels captured by the imaging sensor, determine if rain splash artifacts or bright/dark non-uniformities are present, and remove artifacts in the information representing the images.

### BACKGROUND

### 1. Field of the Invention

The present invention generally relates to imaging systems. More specifically, the invention relates to infrared imaging systems utilized in automotive safety systems.

### 2. Description of Related Art

In adverse weather, especially when rain, fog, or wet snow is present, a layer of moisture or water may form on an external optical or a protective window surface of a camera that is exposed to the environment. It is well known in the art, cameras, such as infrared, long-wave, mid-wave, short-wave, near infrared, and visible cameras are used to detect objects in a scene from a moving vehicle. These objects may be of interest to the driver of an automobile or safety systems of the automobile, so as to prevent or minimize vehicle accidents. The layer of water and moisture that collects on the front window reduces the thermal energy that reaches the infrared long-wave sensitive sensor and reduces the effectiveness of the camera from properly seeing a scene. As a result, the image produced has a low thermal contrast and histogram with limited or reduced usable contents for the driver of the vehicle or other systems using detection algorithms.

Prior art solutions have utilized a heater to eliminate moisture from a window. However, this solution generates major artifacts that reduce the usefulness of the camera system. One type of artifact is a rain/splash artifact. This occurs when wet snow or rain makes contact with a warm window. The moisture becomes warm, and it appears to the driver or detection algorithms as a flash or image burst. These artifacts reduce the effectiveness of the vision system to the driver and/or other automobile safety systems.

The second issue commonly found is that when the moisture is heated by the heater, the moisture tends to linger on the window while the moisture evaporates. As a result, the scene develops bright or sometimes dark corners found in the corner of the image captured by the camera system.

### SUMMARY

An imaging system and method includes an imaging sensor, a processor in communication with the imaging sensor, a protective window or other exposed optical surface located between the camera system and the scene to be captured by the camera system, and a heater system in thermal communication with the window or other exposed optical surface. The imaging sensor configured to capture images of a scene, each of the captured images comprising a plurality of pixels. The processor is configured to receive information representing the images comprising the plurality of pixels captured by the imaging sensor, determine if rain splash artifacts or bright/dark non-uniformities are present, and remove artifacts in the information representing the images.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates an environment having an automobile with an imaging system;

FIG. 2 illustrates a block diagram of the imaging system;

FIG. 3 illustrates an imaging method;

FIG. 4 illustrates an image captured by the imaging system of FIG. 2 and processed by the imaging method of FIG. 3; and

FIG. 5 illustrates another imaging method.

### DETAILED DESCRIPTION

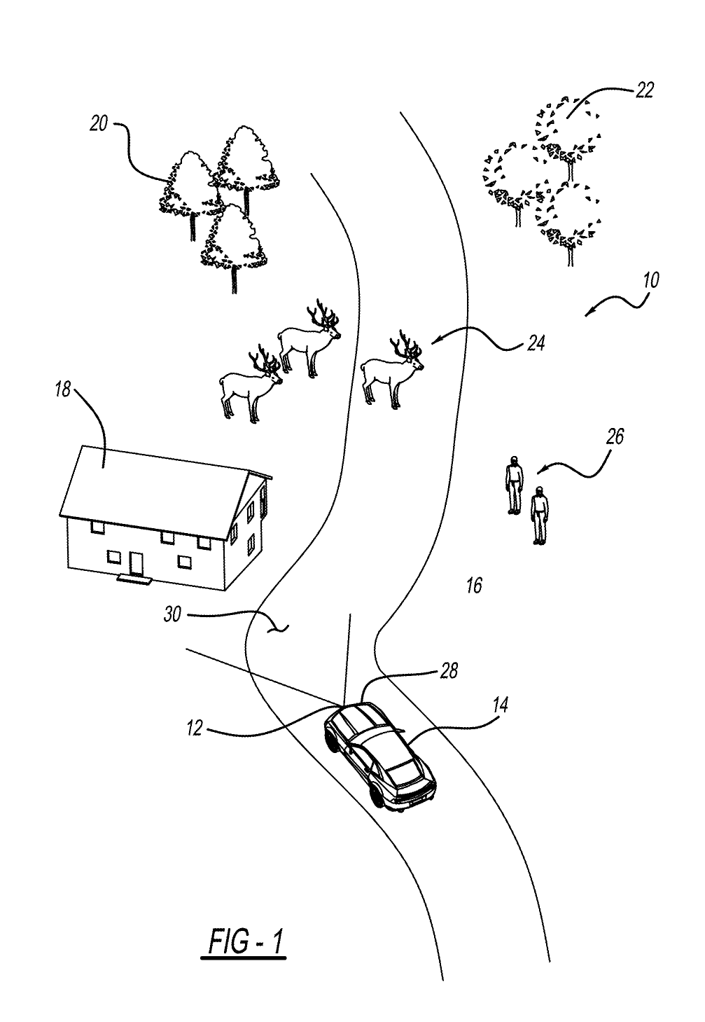

Referring now to FIG. 1, an environment 10 includes an imaging system 12 that is located in a vehicle 14 is shown. It should be understood that the environment 10 may be any type of environment. Here, the environment 10 includes a road 16 wherein the vehicle 14 is traveling on. The environment 10 also includes a number of different objects. For example, the environment 10 includes a building 18, trees 20 and 22. Further, the environment 10 includes a number of moving objects, such as wildlife 24 and persons 26. Of course, it should be understood that the environment 10 may vary significantly. For example, the vehicle 14 may be alternatively traveling on a highway or off-road altogether. Further, the environment 10 could be subject to any which one of a number of different weather conditions, such as sunny, partly cloudy, rainy, foggy, snowy, or any other known weather conditions.

The imaging system 12 may generally be mounted on or near a grill 28 of the vehicle 14. The grill 28 is generally at the front of the car so as to capture a scene 30 forward of a vehicle 14. As the vehicle 14 travels along the road 16, the scene 30 varies so that the imaging system 12 can capture images of the building 18, trees 20 and 22, wildlife 24, and persons 26, if any of these objects are located within the scene 30 as the vehicle 14 moves along the road 16 or elsewhere.

As stated in the background section, if the weather conditions of the environment 10 are adverse, such as rainy or snowy, moisture can develop on a window of the imaging system 12 that may reduce the usefulness of the imaging system 12, especially if the imaging system 12 utilizes an infrared sensor, as will be explained later in this specification. In such an occurrence, the imaging system 12 may not be able to see the objects located in the environment 10. This, in turn, prevents this information from being presented to a driver or algorithms executed by any one of a number of different systems of the vehicle 14.

Also, it should be understood that while the imaging system 12 is shown as being located within a vehicle 14, the imaging system 12 may be located and utilized in any one of a number of different applications. For example, the imaging system 12 may be utilized on any other type of vehicle, such as a boat, plane, truck, construction equipment, tractors, and the like. Further, it should be understood that the imaging system 12 could be utilized separate and apart from any other vehicle 14 shown or previously mentioned. For example, the imaging system 12 could be mounted to a person, structure, and the like. Further, it should be understood that mounting of the system 12 may be such that the mounting of the system 12 makes the system 12 removable so that it can be utilized in any one of a number of different applications.

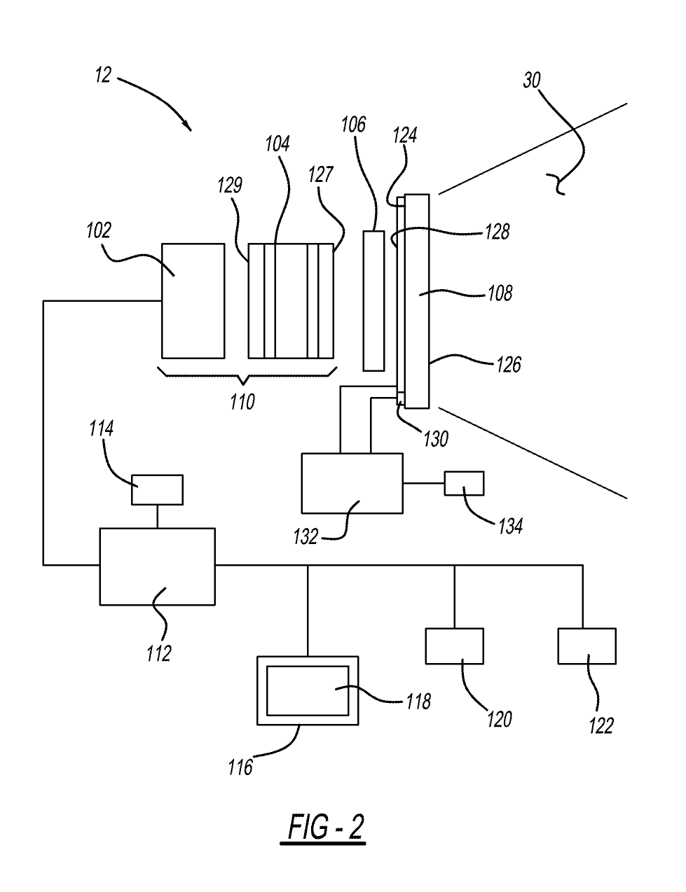

Referring to FIG. 2, a more detailed view of the imaging system 12 for capturing the scene 30 is shown. Here, the imaging system 12 includes an imaging sensor 102, an optical assembly 104, a shutter 106, and a window 108. The sensor 102 may be any type of sensor capable of capturing images. In this example, the sensor 102 is an infrared sensor capable of capturing infrared images. It should also be understood that the sensor 102 may be a sensor capable of capturing different wavelengths of light. For example, the sensor 102 may be a long-wave sensor (7-15 microns wavelength), a mid-wave sensor (2.5-7 microns wavelength), a short-wave sensor (1.1-2.5 microns wavelength), and/or a near infrared sensor (0.75-1.1 microns wavelength). Of course, other sensors capable of capturing other wavelengths outside the ranges mentioned may also be utilized.

The optical assembly 104 may include one or more optics for directing radiation from the scene 30 towards the sensor 102 and has a first side 129 facing towards the sensor 102 and a second side 127 generally facing towards the scene 30 to be captured. It should be understood that the term radiation could mean any type of radiation or visual information, such as light, capable of being received and detected by the sensor 102. Optionally, the system 12 may include a shutter 106 that allows light or radiation to pass for a predetermined period of time.

The window 108 may be any one of a number of different windows capable of allowing the radiation or light to pass through. In this example, the window 108 may be a germanium or silicon window. However, it should be understood that any one of a number of different materials may be utilized in the manufacturing of the window 108. Further, should be understood that the window 108 may not be present at all.

As for location, the window 108 is generally located between the sensor 102 and the scene 30 to be captured. Similarly, the optical assembly 104 is located between the window 108 and the imaging sensor 102. If a shutter 106 is utilized, the shutter 106 may be located between the window 108 and the optical assembly 104. Optionally, the shutter 106 may also be located behind the optical assembly 104 or in front of the window 108—essentially anywhere between the imaging sensor 102 and the scene 30. The sensor 102 and the optical assembly 104 generally form a camera system 110 that is configured to capture images of the scene 30. Each of these captured images comprises a plurality of pixels.

The imaging system 12 also includes a processor 112 configured to receive information representing the images comprising the plurality of pixels captured by the camera system 112. It should be understood that the processor 112 may be a single processor or may be multiple processors working in concert. A memory device 114 may be in communication with the processor 112. The memory device 114 may be configured to store instructions for executing an imaging method to be described later in this specification. However, the memory 114 may be configured to store information received from the camera system 110 regarding the captured images from the scene 30. It should be understood that the memory 114 may be any type of memory capable of storing digital information, such as optical memories, magnetic memories, solid state memories, and the like. Additionally, it should be understood that the memory 114 may be integrated within the processor 112 or separate as shown.

The processor 112 may be connected to a number of different devices that utilize the information representing the images captured from the scene 30. For example, the processor 112 may provide this information to a display device 116 having a display area 118. The display device 116 displays captured images from the scene 30 to a user. In this case, the user may be an operator of the vehicle 14 of FIG. 1. This allows the user to make adjustments in the operation of the vehicle 14.

Also, the processor 112 may also be in communication with other vehicle systems 120 and 122. These other vehicle systems 120 and 122 may be any one of a number of different vehicle systems found in a vehicle. For example, the vehicle systems 120 and/or 122 may be vehicle safety systems, such as airbags, pre-tensioners, and the like. Further, the safety systems may include accident avoidance systems, such as automatic braking, cruise control, automatic steering, and the like. It should be understood that the vehicle systems described are only examples and that the vehicle systems may include any system found in a vehicle. Further, while vehicle systems have been discussed in this specification, the systems 120 and 122 may not be related at all to a vehicle and may be related to some other application of the system 12. These systems 120 and 122 utilize the information regarding the captured images from the scene 30 that have been processed by the processor 112 to perform any one of a number of different algorithms and functions.

As stated before, the system 12 may include the window 108. The window 108 has a first side 124 facing towards the camera system 110 and a second side 126 generally facing towards the scene 30 to be captured. Located on the first side 124 is a heater 128 configured to heat the window 108. The heater 128 may be a heating wire or a heating mesh. The system 12 may also include a temperature sensing element 130 for determining the temperature of the window 108. The temperature sensing element may be any one of a number of different temperature sensing elements. In this example, the temperature sensing element 130 is a thermistor.

Also, it should be understood that if the system 12 does not include the window 108, the heater 128 may be positioned and configured so as to heat the optical assembly 104. For example, the heater 128 and temperature sensing element 130 may be located on the first side 129 of the optical assembly 104.

A processor 132 may be in communication with the heater 128 and the temperature sensing element 130. The processor 132 may be configured to heat the window 108 or optical assembly 104, in the case where the window 108 is not utilized, to a temperature less than or about equal to 100° Celsius. As an example, the processor 132 may be configured to heat the window 108 or optical assembly 104 to approximately 80° Celsius, which is less than 100° Celsius.

Further, the processor 132 may be configured so as to heat the window 108 or optical assembly 104, in the case where the window 108 is not utilized, above the ambient temperature by a certain specified temperature. For example, this certain specified temperature may be 40° Celsius above the ambient temperature. Also, the processor 132 may be configured to activate the heater 128 at certain times or certain temperatures.

Like the processor 112, the processor 132 may be a single processor or may be made of multiple processors working in concert. Also, it should be understood that the processor 112 and the processor 132 may, in fact, be the same processor or set of processors that are managing both the camera system 110 and the heater 128. Further, a memory device 134, similar to the memory device 114 may be in communication with the processor 132. The memory device 134 may contain instructions for configuring the processor 132 regarding heating the window 108 or optical assembly 104 and receiving feedback information from the temperature sensing device 130. Like before, the memory 134 may be any type of memory capable of storing digital information, such as an optical memory, magnetic memory, or solid state memory, and the like. Further, the memory 134 may be integrated within the processor 132 or separate from the processor 132, as shown.

The processor 112 is configured to determine if artifacts are present in the captured image. If this occurs, the processor is configured to remove artifacts from any information representing the images. The artifacts may be caused by moisture coming into physical contact with the second side 126 of the window 108 or the optical assembly 104.

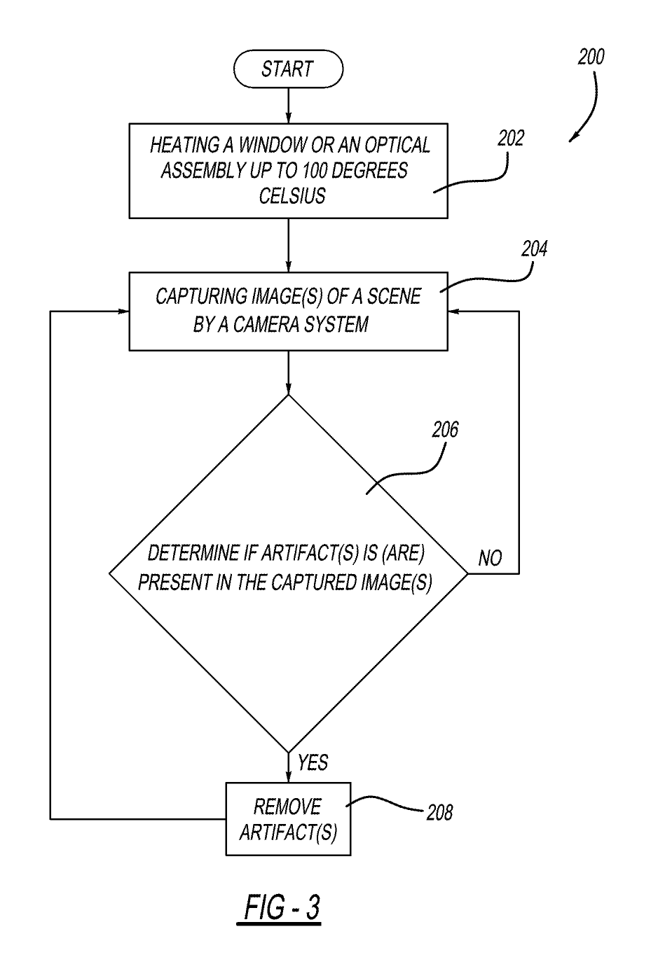

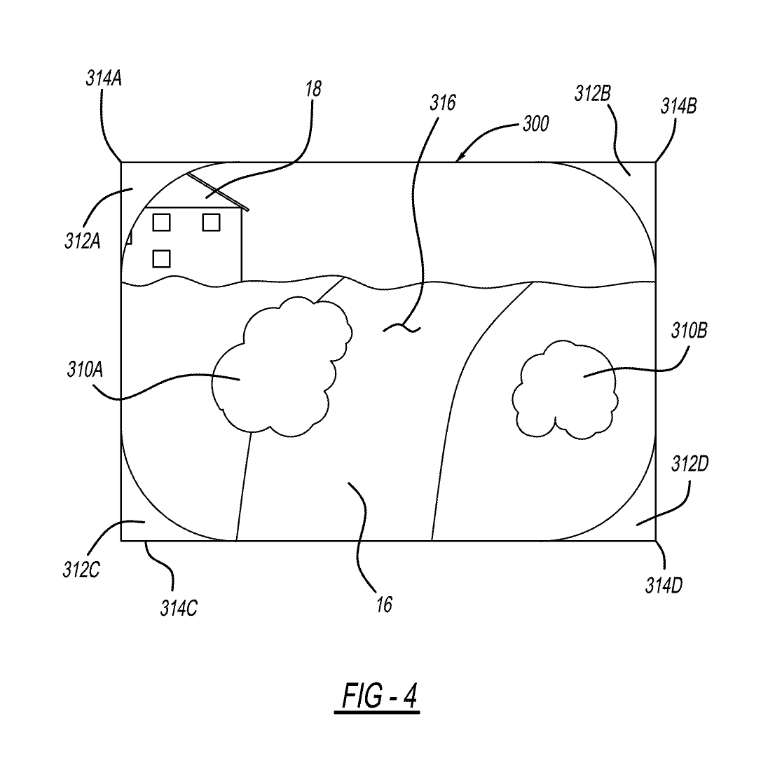

Referring to FIGS. 3 and 4, a method 200 and example image 300 are shown, respectively. The method 200 may be executed by any one of the processors 112 or 132 as shown in FIG. 2. The instructions for this method may be located in the memories 114 or 134. In step 202 the method begins by heating the window 108 or optical assembly 104 to a temperature less than or equal to 100° C. For example, the method may heat the window 108 or optical assembly 104 to 80° C., which is less than 100° C. As described before, this temperature is maintained during the operation of the vehicle 14 of FIG. 1. As stated previously, the temperature in which the window 108 or optical assembly 104 is heated to by a predetermined range or may be based on a set amount above an ambient temperature, for example, 40° C. above the ambient temperature.

In step 204, the camera system 110 captures images of the scene 30. In step 206, the processor 112 determines if artifacts are present in the images. The processor 112 may be configured to determine that artifacts are present in the images by determining which pixels in an image of the plurality of images have changed. Further, this determination can be made if the pixels that change in the image are contiguous and cover a specific area and size. As stated in the background section, when moisture comes into contact with the second side 126 of the window 108 or optical assembly 104, a series of flashes generally occurs, the flashes being the artifacts. These flashes are generally viewed as a significant change in the pixels. Further, theses flashes are contiguous and cover a specific area size.

As such, artifacts can be filtered out by looking not only at which pixels have changed, but also if these pixels are contiguous in nature. If no artifacts are detected, the method returns to step 204. However, if disturbances caused by moisture and heat are detected, the method continues to step 208, wherein the processor 112 is configured to remove artifacts in the images.

Referring to FIG. 4, a sample image 300 is shown. The sample image includes the road 16 and portions of the building 18 from FIG. 1. The image also includes artifacts 310A and 310B caused by moisture coming into contact with the second side 126 of the window 108 or the second side 127 of the optical assembly 104. These artifacts 310A and 310B essentially appear as a series of flashes but represent moisture coming into contact with the second side of 126 of the window 108 or the second side 127 of the optical assembly 104. In addition to these artifacts, there are also other artifacts 312A, 312B, 312C, and 312D. These artifacts represent moisture that has accumulated in the edges of the sample image 300. As the moisture collecting on the second side 126 of the window 108 or the second side 127 of the optical assembly 104 is heated, the moisture may accumulate on the edges of the image 300. The artifacts 310A-310B and 312A-312D may be removed by applying a low pass filter to the information representing the pixels that changed in the image. Here, the pixels are located where the artifacts 310A-310B and 312A-312D are located.

The processor 12 may also be further configured to remove the artifacts by determining a splash profile by subtracting a splash image, such as artifacts 310A and 310B from a previously captured image or a low pass filtered version of previously captured image. Generally, the splash image is the pixels that changed in the image. This splash pattern is removed from the sample image 300 and fading of the removal of the splash pattern from the plurality of images is performed as the artifacts are no longer present in the captured images. Further, the splash pattern may be located near the edges of 314A, 314B, 314C, and 314D of the image 310 instead of, or in addition to a central area 316 of the image 300.

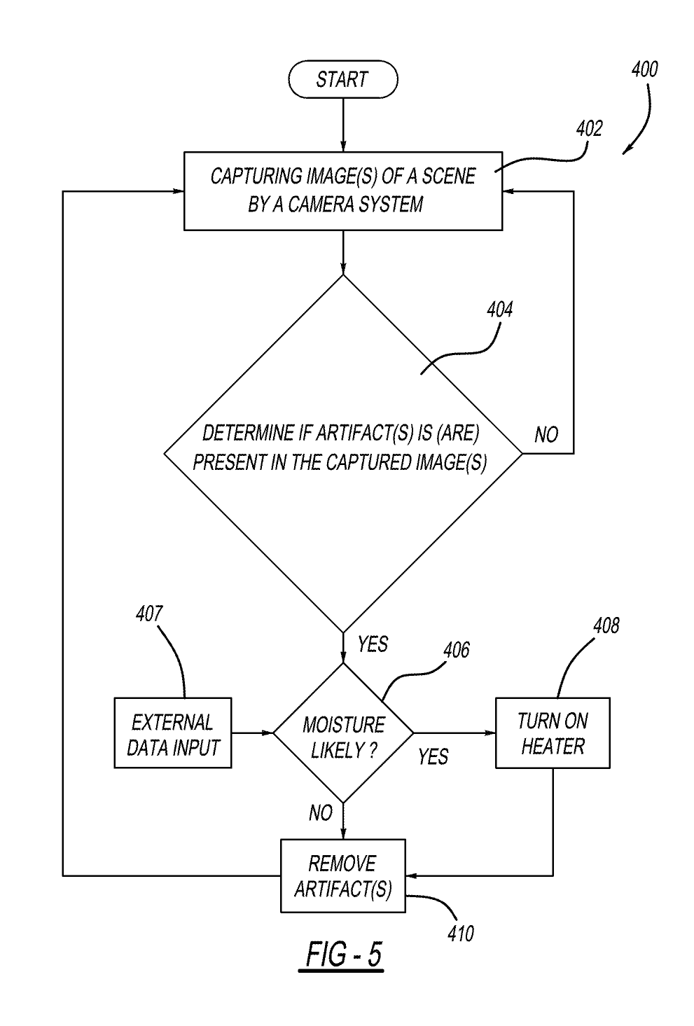

Referring to FIG. 5, another method 400 is shown that may be executed by any one of the processors 112 or 132 as shown in FIG. 2. The instructions for this method may be located in the memories 114 or 134. In step 402, the camera system 110 captures images of the scene 30. In step 404, the processor 112 determines if artifacts are present in the images. The processor 112 may be configured to determine that artifacts are present in the images by determining which pixels in an image of the plurality of images have changed. Further, this determination can be made if the pixels that change in the image are contiguous and cover a specific area and size. As stated in the background section, when moisture comes into contact with the second side 126 of the window 108 or optical assembly 104, a series of flashes generally occurs, the flashes being the artifacts. These flashes are generally viewed as a significant change in the pixels. Further, theses flashes are contiguous and cover a specific area size.

In step 406, the processor 112 determines if moisture is the likely cause of the artifacts that are present in the captured images. This determination can be made by not only using the captured images but also using external data 407. The external data 407 could include data from other sensors, such as environmental sensors, such as rain detecting windshield wipers that can detect if the vehicle 14 is traveling in a location that is likely to have moisture. Further, the external data 407 could be data from a database that tracks the weather conditions of an area where the vehicle 14 is traveling. Additionally, the external data 407 could also include information from other vehicle systems, such as a determination if the windshield wipers of the vehicle and/or defroster of a vehicle are being utilized. If the windshield wipers and/or defroster, and/or any other moisture related system are being utilized, this information could be useful in determining if moisture is the likely cause of the artifacts.

If moisture is determined to be the likely source of the artifacts in the captured images, the method 400 turns on heater 128 in step 408. As stated previously, the temperature in which the window 108 or optical assembly 104 is heated to by a predetermined range or may be based on a set amount above an ambient temperature, for example, 40° C. above the ambient temperature. In this method, the heater 128 is only on selectively if moisture is determined to be present. Otherwise, the method 400 is essentially always looking to remove artifacts but will only heat the window 108 or optical assembly 104 when moisture is determined to be present.

In step 410, the processor 112 is configured to remove artifacts from the captured images. The methodologies described in method 200 regarding removing artifacts from the captured images are equally applicable in this method and will not be described again. After artifacts are removed, the method 400 returns to step 402.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation, and change, without departing from the spirit of this invention, as defined in the following claims.

1. An imaging system, the imaging system comprising
an imaging sensor, the imaging sensor configured to capture images of a scene, each of the captured images comprising a plurality of pixels;
a processor in communication with the imaging sensor, the processor configured to receive information representing the images comprising the plurality of pixels captured by the imaging sensor;
a window or optical assembly located between the imaging sensor and the scene to be captured by the imaging sensor, the window or optical assembly having a first side facing the imaging sensor and a second side facing the scene to be captured;
a heater system in thermal communication with the window or optical assembly;
wherein the heater system is configured to selectively heat the window or optical assembly to a temperature less than or equal to 100 degrees Celsius;
wherein the processor is configured to determine if one or more artifacts are present in the captured images; and
wherein the processor, after determining that one or more artifacts are present in the captured images, is configured to remove the one or more artifacts in the information representing the images.

2. The system of claim 1, wherein the processor is configured to determine if one or more artifacts are present in the captured images by determining which pixels have changed in an image of the plurality of images and if the pixels that changed in the image are contiguous and cover a specific area size.

3. The system of claim 1, wherein the processor is configured to remove the one or more artifacts by being configured to:
determine a splash profile by subtracting a splash image from a previously captured image or a low pass image, wherein the splash image is the pixels that changed in the image;
remove the splash pattern from the image; and
fade the removal of splash pattern from the plurality of images as moisture is removed from the second side of the window or the optical assembly.

4. The system of claim 3, wherein the removal of splash pattern from the image is weighted higher in near edges of the image than a center area of the image.

5. The system of claim 1, wherein the processor is configured to determine if moisture is present on the window or the optical assembly and instruct the heater system to heat the window or optical assembly to a temperature less than or equal to 100 degrees Celsius when moisture is present.

6. The system of claim 5, wherein the processor is configured to determine if moisture is present on the window or the optical assembly by analyzing the captured images.

7. The system of claim 6, wherein the processor is further configured to determine if moisture is present on the window or the optical assembly by analyzing external data.

8. The system of claim 1, wherein the heater system is configured to heat the window or the optical assembly to a temperature above the ambient temperature by a specific number of degrees Celsius.

9. The system of claim 8, wherein the specific number of degrees Celsius is 40 degrees Celsius.

10. The system of claim 1, wherein the window is a germanium window or a silicon window.

11. The system of claim 1, wherein the imaging sensor comprises at least one of a long-wave sensor, a mid-wave sensor, a short-wave sensor, and/or a near-infrared sensor.

12. The system of claim 1, wherein the heater system further comprises:
a heating element in thermal communication with the window or the optical assembly;
a temperature sensing element in thermal communication with the window or the optical assembly;
a control device in communication with the heating element and the temperature sensing element, the control device configured to measure the temperature of the window or the optical assembly via the temperature sensing element and provide a current to the heating element in response to the temperature of the window or the optical assembly.

13. The system of claim 1, wherein the system is located within an automobile.

14. An imaging method for an imaging system, the method comprising the steps of:
capturing images of a scene by an imaging sensor, each of the captured images comprising a plurality of pixels;
selectively heating a window or an optical assembly located between the imaging sensor and the scene to a temperature less than or equal to 100 degrees Celsius;
determining if one or more artifacts are present in the captured images; and
removing the one or more artifacts in the images.

15. The method of claim 14, wherein the step of determining that if one or more artifacts are present in the captured images includes the step of determining which pixels have changed in an image of the plurality of images and if the pixels that changed in the image are contiguous and cover a specific area size.

16. The method of claim 14, further comprising the steps of:
determining a splash profile by subtracting a splash image from a previously captured image or a low pass image, wherein the splash image is the pixels that changed in the image;
removing the splash pattern from the image; and
fading the removal of splash pattern from the plurality of images as moisture is removed from the window or optical assembly.

17. The method of claim 16, wherein the step of removing the splash pattern from the image is weighted higher in near edges of the image than a center area of the image.

18. The method of claim 16, further comprising the steps of:
determining if moisture is present on the window or the optical assembly and;
heating the window or optical assembly to a temperature less than or equal to 100 degrees Celsius when moisture is present on the window or the optical assembly.

19. The method of claim 18, further comprising the step of determining if moisture is present on the window or the optical assembly by analyzing the captured images.

20. The method of claim 14, wherein the imaging sensor comprises at least one of a long-wave sensor, a mid-wave sensor, a short-wave sensor, and/or a near-infrared sensor.
